(19) United States
(12) Patent Application Publication
(10) Pub. No.: US 2020/0392381 A1
(43) Pub. Date: Dec. 17, 2020

(54) POLYMER ADDITIVES FOR PRESSURE-SENSITIVE ADHESIVES

(71) Applicant: ChemHost Inc., Hatfield, PA (US)

(72) Inventors: Lingling QI, Nanjing (CN); Huili LUO, Nanjing (CN); Lifeng ZHANG, Lansdale, PA (US); Jiaqian NI, Wynnewood, PA (US); Joshua CHONG, Lansdale, PA (US)

(73) Assignees: ChemHost Inc., Hatfield, PA (US); PennAdditives, LLC, Nanjing (CN)

(21) Appl. No.: 16/440,450

(22) Filed: Jun. 13, 2019

(51) Int. Cl. C09J 11/08; C09J 7/38; C08F 220/18; C08F 220/34; C08F 220/60; C08F 220/04; C08F 212/04

(52) U.S. Cl. CPC C09J 11/08; C09J 7/385; C08F 220/18; C08F 220/34; C08F 2220/1808; C08F 220/04; C08F 212/04; C09J 2201/606; C08F 220/60

(57) ABSTRACT

Core-shell copolymers are described, along with methods of making same, which provide improved adhesion and cohesion when used as additives in pressure sensitive adhesives. The core-shell polymers contain copolymers with ureido functionality in the shell region only, while the core region is substantially free of ureido functionality.

### BACKGROUND OF THE INVENTION

Pressure sensitive adhesives (PSAs) may be applied in several forms: as solutions, emulsions or as hot melts. The performance of pressure-sensitive adhesives comprises a balance of three properties: peel strength (a measure of adhesion), tack, and shear strength (a measure of cohesion). In general, any approach which serves to improve peel and tack results in a decrease of shear strength. Any change which improves shear strength has the effect of worsening peel and tack. For example, when using a polymer additive as a tackifier, increases in polymer molecular weight may serve to improve shear strength at the expense of peel and tack.

Incorporation of highly polar monomers, such as polymerizable carboxylic acids, or the inclusion of cross-linking monomers, such as N-methylol acrylamide, may also provide increased shear strength with the concomitant loss of peel and tack. To improve the cohesive strength of pressure-sensitive adhesives without impairing the adhesive properties, a very slight crosslinking is often employed by the use of multifunctional monomers.

There is an unmet need for adhesive formulations that provide a good adhesion/cohesion balance. Particularly there is a need for any solution that makes it possible to improve the cohesion of a pressure-sensitive adhesive without resulting in a decrease in the adhesion properties, and at a cost which is compatible with the application.

### SUMMARY OF THE INVENTION

It is an object of this invention, therefore, to provide additives for improving the cohesion of pressure sensitive adhesives without compromising the adhesive properties, and to do so in a cost-effective manner. It is a related object of this invention to provide a method for using such additives in adhesive compositions.

These and other objects of the invention which will become apparent from the following description are achieved by using an additive with copolymers having ureido groups that are added directly to the waterborne pressure sensitive adhesive in relatively small quantities.

The additive is a polymer that possesses a core-shell structure wherein the ureido groups are concentrated in the shell portion of the structure. When these core-shell polymers are added to the pressure sensitive adhesive in relatively small quantities, improved adhesion and cohesion are observed, while requiring less ureido monomer material than prior art PSAs, which have the ureido functionality dispersed throughout.

### DETAILED DESCRIPTION OF THE INVENTION

All patents, published patent applications and articles referenced in this detailed description are hereby incorporated by reference in their entireties.

The use of the terms “a” and “an” is intended to include one or more of the element described. Lists of exemplary elements are intended to include combinations of one or more of the element described.

The term “may” as used herein means that the use of the element is optional and is not intended to provide any implication regarding operability.

Surprisingly and as more fully described herein, it has been found that copolymer additives having ureido groups are uniquely able to significantly increase the cohesion of pressure sensitive adhesive compositions without compromising the adhesion (peel/tack) performance of the adhesives if they are added directly as adhesion-improving compounds to the waterborne pressure sensitive adhesive in relatively small quantities.

As used herein, copolymer means a polymer made by reaction of two or more different monomers, with units of more than one kind.

Specifically, the copolymer additives of the claimed invention are present in core-shell polymers that consist of at least two different copolymers, one forming a core region of the polymer particle and another surrounding the core and forming a shell region of the polymer particle. An overview of core-shell polymer properties, preparation and applications is provided in “Core-Shell Polymers: a Review,” Ramli, Ros Azlinawati, et al., RSC Advances, 2013, 3, 15543, which is incorporated herein by reference as if fully set forth. In the copolymers of the claimed invention, the ureido functional groups are concentrated in the shell region and provide improved properties when added to an adhesive composition, while also being more cost-effective than having the ureido functional groups dispersed through the entire polymer particle.

This results in an improvement in the cohesion of an adhesive system is achieved through the addition of very small amounts of the copolymer additives, without it being necessary for the adhesive polymer to contain ureido functionality throughout the entire polymer particle. Additives incorporating these novel copolymers can be prepared via emulsion polymerization and thus be employed to replace the polymers in a solvent phase which are costly and detrimental to the environment. The high cohesive strength associated with the adhesives incorporating these novel copolymers according to the present invention also makes them compatible with the use of tackifiers employed to increase adhesion to substrates of low surface energy, such as polyolefins.

Copolymers

The copolymers which form the shell region of the core-shell polymer are copolymers in which some of the monomers used to create the copolymer have ureido functionality. The copolymers that form the core region are formed from monomers which do not have ureido functionality. The monomers which do not have ureido functionality are also referred to herein as non-ureido, radical copolymerizable monomers.

The shell copolymers are formed by polymerizing one or more monomers containing ureido functionality with f non-ureido, radical copolymerizable monomers. The shell copolymers preferably contain from 2 to 18 percent by weight, more preferably 3 to 12 percent by weight, of monomers having ureido functionality, with the balance of the copolymer comprising other, non-ureido, radical copolymerizable monomers. The core copolymers are comprised entirely of non-ureido, radical copolymerizable monomers. Each group of monomers is described in greater detail below.

Monomers Containing Ureido Functionality

The monomers containing ureido functionality preferably have the chemical structure:

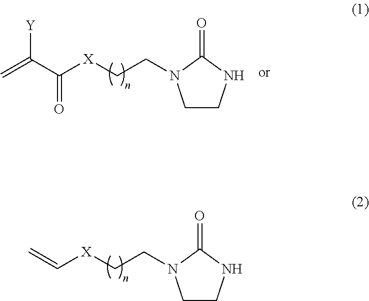

wherein n is 1 through 5, X is oxygen, NH or NR where R is a methyl or ethyl group and Y is H or CH₃.

More preferably, n is 1, X is oxygen, and Y is CH₃.

Suitable ureido containing monomers include, but are not limited to: ethylimidazolidone (meth)acrylate, ethylimidazolidone (meth)acrylamide and 1-[2-[[2-hydroxy-3-(2-propenyloxy)propyl]amino]ethyl]-2-imidazolidone (CAS #85356-84-9); 2-(2-Oxo-1-imidazolidinyl)ethyl methacrylate (CAS #86261-90-7), also called N-(2-methacryloyloxyethyl) ethylene urea or 2-ureiidoethylmethacrylate (referred to herein as WAM III); and N-[2-(2-oxo-1-imidazolidinyl)ethyl] methacrylamide (CAS #3089-19-8), also known as methacrylamidoethylethylene urea. Preferred ureido containing monomers include: 2-(2-Oxo-1-imidazolidinyl)ethyl methacrylate (CAS #86261-90-7), also known as 2-ureiidoethylmethacrylate (referred to herein as WAM III), and N-[2-(2-Oxo-1-imidazolidinyl)ethyl]methacrylamide (CAS #3089-19-8).

Non-Ureido, Radical Copolymerizable Monomers

The non-ureido radical copolymerizable monomers that make up the copolymers of the invention, include, but are not limited to, C1 through C20 alkyl (meth) acrylates, vinyl esters of carboxylic acids containing up to and including 20 carbon atoms, vinyl aromatic compounds containing up to and including 20 carbon atoms, unsaturated acids, aromatic vinyl compounds and further monomers. Preferred alkyl (meth)acrylates include, but are not limited to, methyl methacrylate, methyl acrylate, n-butyl acrylate, ethyl acrylate, 2-ethylhexyl acrylate and t-octyl acrylate. Preferred vinyl esters of carboxylic acids containing from 1 to 20 carbons include, but are not limited to, vinyl laurate, vinyl stearate, vinyl propionate, vinyl esters of Versatic™ acid and vinyl acetate. Preferred vinyl aromatic compounds include, but are not limited to, vinyl toluene, α- and π-methylstyrenes, α-butylstyrene, 4-n-butylstyrene, 4-n-decylstyrene and, more preferably, styrene. Preferred unsaturated acids include, but are not limited to, acrylic acid, methacrylic acid, alpha-haloacrylic acids (preferably chloroacrylic acid), itaconic acid, maleic acid, and fumaric acid. A more preferred unsaturated acids is acrylic acid. Preferred further monomers include, but are not limited to monomers containing hydroxyl groups, preferably C1 through C10 hydroxyalkyl (meth)acrylates and (meth)acrylamide. Preferred further monomers also include phenyloxyethyl glycol mono(meth)acrylate, glycidyl acrylate, glycidyl methacrylate, amino (meth)acrylates such as 2-aminoethyl (meth)acrylate and other heteroatom containing monomers such as N-vinyl caprolactam.

A preferred combination of ureido and non-ureido monomers is 2-ureiidoethylmethacrylate and butyl acrylate.

Synthesis of the Invention Additive

In a preferred embodiment, synthesis of the invention additive is carried out by emulsion polymerization. The additive is, therefore, an emulsion polymer. The polymerization reaction is preferably conducted under inert atmosphere in the presence of radical initiators at a temperature of from 50 to 100 degrees Celsius, more preferably from 60 to 90 degrees Celsius. The polymerization medium preferably is either water or mixtures of water and water-miscible liquids such as methanol. More preferably, the polymerization medium is water.

The emulsion polymerization can be carried out as a batch process or as a semi-continuous process. Preferably, the polymerization is a semi-continuous process in which a portion of the polymerization ingredients are placed in a reactor, heated to the polymerization temperature and incipiently polymerized. Then, the rest of the polymerization ingredients are fed to the polymerization zone, usually via a number of discrete feed streams, of which one or more contains the monomers in a pure or emulsified form, continuously, stepwise or with a superimposed concentration gradient, while maintaining polymerization.

The emulsifying systems employed in the emulsion polymerization process according to the invention are chosen from the range of surfactants that possess an appropriate hydrophilic/lipophilic balance. The surfactants are preferably employed in amounts ranging from 0.1 to 5 percent by weight and preferably from 0.2 to 2 percent by weight of active substance based on the monomers to be polymerized. The surfactants to be used are preferably anionic surfactants or mixture of anionic surfactants and nonionic surfactants, depending on the nature of the monomers employed.

Preferable anionic surfactants include, but are not limited to, sodium lauryl sulphate, nonylphenol sulphate ethoxylated preferably with from 10 to 25 moles of ethylene oxide, dodecylbenzenesulphonate, and ethoxylated fatty alcohol sulphates. The nonionic surfactants include, but are not limited to, nonylphenols ethoxylated with from 10 to 40 moles of ethylene oxide, and ethoxylated fatty alcohols.

Preferable water-soluble initiators for emulsion polymerization include, but are not limited to, ammonium and alkali metal salts of peroxydisulfuric acid, prefereably ammonium persulfate, sodium persulfate, hydrogen peroxide, or organic peroxides (prefereably tert-butyl hydroperoxide or redox initiator systems which are made up of at least one preferably inorganic reducing agent and one inorganic or organic oxidizing agent).

When a redox initiator system is used, the oxidizing component is preferably one of the aforementioned initiators for the emulsion polymerization. Preferable reducing components include, but are not limited to, alkali metal salts of sulfurous acid, preferably sodium sulfite, sodium hydrogen sulfite, alkali metal salts of pyrosulfurous acid such as sodium disulfite, bisulfite addition compounds of aliphatic aldehydes and ketones, such as acetone bisulfite, or reducing agents such as hydroxymethanesulfinic acid and the salts thereof, or ascorbic acid.

Preferred redox initiator systems include, but are not limited to, ascorbic acid/iron(II) sulfate/sodium peroxodisulfate, tert-butylhydroperoxide/sodium disulfite, and tert-butyl hydroperoxide/sodium hydroxymethane sulfinic acid. The redox initiator systems are preferably used together with soluble metal compounds whose metallic component can exist in more than one valence state.

The amount of initiator is preferably from 0.05 to 5 percent by weight, and more preferably from 0.1 to 1 percent by weight, based on the monomers to be polymerized. Alternatively, a number of different initiators can be used for the emulsion polymerization.

During polymerization, chain transfer agents (also known as modifiers or regulators) are preferably used in amounts from 0 to 5 parts and more preferably 0 to 2 parts by weight, based on 100 parts by weight of the monomers to be polymerized, by means of which the molar mass is reduced. Preferable chain transfer agents include, but are not limited to, compounds having a thiol group such as tert-butyl mercaptan, thioglycolic acid ethyl acrylate, mercaptoethynol, mercaptopropyl trimethoxysilane, tert-dodecyl mercaptan and dodecyl mercaptan. The regulators contain no polymerizable ethylenically unsaturated groups. The regulators stop the polymerizing chain and are therefore attached to the ends of the polymer chains.

The emulsion polymerization produces aqueous dispersions of the polymer usually having a solid content of from 15 to 50 percent by weight, preferably from 30 to 45 percent by weight. The copolymer thus prepared is preferably used in the form of its aqueous dispersion.

The present invention relates to the use of the copolymers containing ureido groups in the shell region of a core-shell polymer as cohesion improvement additives to aqueous emulsion pressure sensitive adhesive systems. The amount in which the additive of the invention is used is preferably from 1 to 10 percent by weight, more preferably from 2 to 6 percent by weight of the solid content of the to the weight of the overall formulation.

### EXAMPLES

The invention is disclosed in more detail below with reference to working examples. The examples are intended to demonstrate preferred embodiments of the invention and not to limit the invention in any way.

### Example 1: Synthesis of Copolymer 1—Prior Art Additive

A mixture of 1000 g of water, 50 g of a 30 percent by weight aqueous solution of sodium lauryl sulfate emulsifier, was initially placed in a polymerization vessel and heated to 86 degrees Celsius. 12 grams of an 8 percent by weight aqueous solution of ammonium persulfate initiator solution was added into the vessel and held for 2 minutes while stirring. Then, feed 1 was continuously metered into the polymerization vessel over the course of 60 minutes. After the completion of adding feed 1, feed 2 was continuously metered into the polymerization vessel over the course of 60 minutes. Simultaneously during the metered additions of feed 1 and feed 2, a 120 g aliquot of an aqueous solution comprising 0.5 g of ammonium persulfate initiator was continuously added over the course of 130 minutes. Thus, the addition of ammonium persulfate initiator solution extends for 10 minutes after the completion of adding feeds 1 and 2. During the emulsion polymerization, the reaction vessel was maintained at the temperature of 86 degrees Celsius.

After the end of adding feed 2, the polymerization temperature was held at 86 degrees Celsius for 30 minutes. After the end of the 30 minutes hold, the temperature was cooled to 50 degrees C. and 100 g water was added. Then, the following were introduced into the reaction vessel: 20 grams of a 1.5 percent by weight ferrous sulfate aqueous solution and 15 grams of a 6.67 percent by weight D-isoascorbic acid aqueous solution. Thereafter, the reaction vessel was cooled to room temperature. Then,15 g of a 28 percent by weight aqueous ammonia solution was added and the emulsion was filtered through a filter of 250 micron mesh size.

Feed 1:

300 grams of deionized water

25 grams (26 mmole) of 30 percent by weight sodium lauryl sulfate (SLS)

11 grams (127.8 mmole) of methacrylic acid (MAA)

120 grams (302.27 mmole) of 2-ureidoethylmethacrylate as Wet Adhesion Monomer, WAM III (50 percent by weight aqueous solution)

485 grams (3.784 mole) of butyl acrylate

3 grams (12.1 mmole) of Diallyl phthalate (DAP) crosslinking agent

Feed 2:

300 grams of deionized water

25 grams (26 mmole) of 30 percent by weight SLS

11 grams (127.8 mmole) of MAA

120 grams (302.37 mmole) of WAM III (50 percent by weight aqueous solution)

485 grams (3.784 mole) of butyl acrylate

1.3 grams (6.4 mmole) of n-dodecyl mercaptan

### Example 2 Synthesis of Copolymer 2—Inventive Additive

The procedure of Example 1 is repeated except the composition of feed 1 and 2 are as follows:

Feed 1:

300 grams of deionized water

25 grams (26 mmole) of 30 percent by weight SLS

60 grams (599.3 mmole) of methyl methacrylate (MMA)

485 grams (3.784 mole) of butyl acrylate

3 grams (12.1 mmole) of Diallyl phthalate (DAP) crosslinking agent

Feed 2:

300 grams of deionized water

25 grams (26 mmole) of 30 percent by weight SLS

11 grams (127.8 mmole) of MAA

110 grams (277.5 mmole) of WAM III (50 percent by weight aqueous solution)

485 grams (3.784 mole) of butyl acrylate

1.3 grams (6.4 mmole) of n-dodecyl mercaptan chain transfer agent

The cohesion enhancement of pressure sensitive adhesives was assessed by comparing commercially available waterborne PSA emulsion products available on the market with and without the incorporation of inventive compounds at the amount of 5 percent by weight.

Preparation of Coatings

The adhesive solutions were cast on a polyethylene terephthalate (PET) film of 100 microns (4 mil) thickness, air dried for 15 minutes, then dried for 10 minutes at 105 degrees Celsius in a forced air oven. Then, the coated PET film was cut into 35 cm×2.5 cm strips. The dried adhesive layer thickness on the PET film was 25 microns (1 mil).

Peel Adhesion

Peel adhesion at 180 degrees angle between the backing film and the adherend stainless-steel panel was measured according to Test Method number 101 of the Pressure Sensitive Tape Council (PSTC), 15^{th} Edition. adapted as follows. The peel strength was measured after wetting out a stainless steel (SS) panel for 30 minutes. The peel strength was automatically recorded by the instrument. All the testing was performed at 25 degrees C.

Shear Holding Power

Shear holding power was measured according to PSTC Test Method (15^{th} Edition) number 107. adapted as follows. The holding power was measured under a shear load of 1 kg on a 2.5 cm by 2.5 cm area, applied after wetting out the test panel for 10 minutes. All testing was performed at 85 degrees C.

Application Example

In each of 5 waterborne pressure sensitive adhesive products, labeled A through E in Table 1, the adhesive was supplemented with 5 percent by weight of the copolymers according to the present invention from Examples 1 and 2, in the form of their 34 percent solids aqueous solution. The waterborne PSAs are about 50 to 60 percent solids polyacrylate emulsions. The performance test results in Table 1 below clearly demonstrated that the invention copolymers could significantly increase the cohesive strength of a PSA formula without compromising the peel and tack properties.

TABLE 1

| PSA | Test | | With added 5% | With added 5% |
|---|---|---|---|---|
| Products | Properties | Control | Copolymer 1 | Copolymer 2 |
| A | Peel (N/cm) | 5.40 | 5.11 | 5.45 |
| | Shear (time) | 18 min | >48 hrs | >48 hrs |
| B | Peel (N/cm) | 5.28 | 5.23 | 5.57 |
| | Shear (time) | 34 min | >48 hrs | >48 hrs |
| C | Peel (N/cm) | 5.99 | 5.75 | 5.82 |
| | Shear (time) | 34 min | >48 hrs | >48 hrs |
| D | Peel (N/cm) | 4.96 | 5.04 | 4.84 |
| | Shear (time) | 18 min | >24 hrs | >48 hrs |
| E | Peel (N/cm) | 5.14 | 5.11 | 5.34 |
| | Shear (time) | 35 min | >48 hrs | >48 hrs |

The additive containing Copolymer 1 (prior art) has ureido functionality throughout its molecular structure, The additive containing Copolymer 2 (the inventive copolymer) has ureido functionality only in the shell region of a core-shell polymer. The results in Table 1 prove that the additive containing Copolymer 2 is equally effective, or even more effective, than the additive containing Copolymer 1 in a PSA system. The additive with ureido functionality only in the shell structure performs better and is more cost effective to produce than the prior art additive which has ureido functionality throughout its molecular structure.

From the foregoing description, one skilled in the art can easily ascertain the essential characteristics of this invention, and without departing from the spirit and scope thereof, can make various changes and modifications of the invention to adapt it to various usages and conditions.

What is claimed is:

1. An additive for enhancing the adhesive properties of a pressure sensitive adhesive, comprising:
a core-shell polymer comprising a core region and a shell region surrounding the core region, wherein the shell region comprises a first copolymer formed from at least one monomer with ureido functionality and the core region is substantially free of ureido functionality.

2. The composition of claim 1, wherein the at least one monomer having ureido functionality has a structural formula selected from the group of: 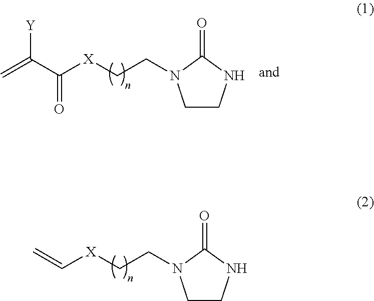
wherein n is 1 through 5, X is oxygen, NH or NR where R is CH₃ or C₂H₂CH₃ and Y is H or CH₃.

3. The composition of claim 2, wherein n is 1, X is oxygen and Y is CH₃.

4. The composition of claim 1, wherein at least one monomer having ureido functionality is 2-ureiidoethylmethacrylate.

5. The composition of claim 1, wherein the first copolymer comprises at least one monomer with ureido functionality copolymerized with at least one non-ureido radical copolymerizable monomer.

6. The composition of claim 4, wherein the at least one monomer having ureido functionality comprises between 2 to 10 molar percent of the shell region.

7. The composition of claim 1 wherein the core region comprises a second copolymer formed from a plurality of non-ureido, radical copolymerizable monomers.

8. The composition of claim 1, wherein the shell region comprises from 3 to 20 percent by weight of monomers containing ureido functionality, based on the total weight of the shell region.

9. The composition of claim 1, wherein the shell region comprises from 3 percent to 15 percent by weight of monomers containing ureido functionality, based on the total weight of the shell region.

10. The composition of claim 1, wherein the core region comprises less than 5 percent by weight of monomers containing ureido functionality, based on the total weight of the core region.

11. The composition of claim 1, wherein the core-shell polymer contains 1.5% to 15% by weight of monomers containing ureido functionality, based on the total weight of the core-shell polymer.

12. The composition of claim 1 wherein the core-shell polymer is an emulsion polymer.

13. The composition of claim 5, wherein the at least one non-ureido, radical copolymerizable monomer is selected from the group consisting of alkyl (meth) acrylates, vinyl esters of carboxylic acids, vinyl aromatic compounds, unsaturated acids, aromatic vinyl compounds and combinations thereof.

14. The composition of claim 1, wherein the monomer having ureido functionality is selected from the group consisting of: ethylimidazolidone (meth)acrylate, ethylimidazolidone (meth)acrylamide and 1-[2-[[2-hydroxy-3-(2-propenyloxy)propyl]amino]ethyl]-2-imidazolidone (CAS #85356-84-9); 2-(2-Oxo-1-imidazolidinyl)ethyl methacrylate (CAS #86261-90-7), also called N-(2-methacryloyloxyethyl) ethylene urea; and N-[2-(2-oxo-1-imidazolidinyl)ethyl]methacrylamide (CAS #3089-19-8), also known as methacrylamidoethylethylene urea.

15. The composition of claim 1, wherein the at least one monomer having ureido functionality is selected from the group consisting of 2-(2-Oxo-1-imidazolidinyl)ethyl methacrylate (CAS #86261-90-7) and N-[2-(2-Oxo-1-imidazolidinyl)ethyl]methacrylamide (CAS #3089-19-8).

16. A method for formulating an additive for an adhesive, comprising:
forming a core-shell polymer having:
a copolymer with ureido functionality in the shell region, and
a core region that is substantially free of ureido functionality.

17. The method of claim 16, wherein the forming step further comprises:
a.) polymerizing, in a reaction vessel, non-ureido, radical copolymerizable monomers to form a core region of the core-shell polymer.
The method of claim 17, further comprising:
b.) polymerizing a copolymer from a monomer with ureido functionality and a non-ureido, radical copolymerizable monomer.
c.) performing the step b after the step a in the same reaction vessel as step a.

18. The method of claim 17 wherein the step b is performed using a monomer with ureido functionality selected from the group consisting of 2-(2-Oxo-1-imidazolidinyl)ethyl methacrylate (CAS #86261-90-7) and N-[2-(2-Oxo-1-imidazolidinyl)ethyl]methacrylamide (CAS #3089-19-8).

19. The method of claim 16 wherein the non-ureido, radical copolymerizable monomer is selected from the group consisting of alkyl (meth) acrylates, vinyl esters of carboxylic acids, vinyl aromatic compounds, unsaturated acids, aromatic vinyl compounds and combinations thereof.

20. An aqueous pressure sensitive adhesive comprising from 1 to 10 percent by weight of an additive comprising a core-shell polymer having ureido functionality in a shell region of the core-shell polymer and a core region that is substantially free of ureido functionality.
